(19) United States
(12) Patent Application Publication
(10) Pub. No.: US 2024/0298679 A1
(43) Pub. Date: Sep. 12, 2024

(54) METHOD AND SYSTEM FOR PRE-PREPARED BREADED MEAT

(71) Applicant: Stampede Culinary Partners, Inc., Bridgeview, IL (US)

(72) Inventor: Dennis Gruber, Homer Glen, IL (US)

(73) Assignee: Stampede Culinary Partners, Inc., Bridgeview, IL (US)

(21) Appl. No.: 18/591,654

(22) Filed: Feb. 29, 2024

Related U.S. Application Data
(60) Provisional application No. 63/488,811, filed on Mar. 7, 2023.

(51) Int. Cl. A23L 13/00; A23L 5/10; A23L 13/75

(52) U.S. Cl. CPC A23L 13/03; A23L 5/11; A23L 5/13; A23L 13/75

(57) ABSTRACT

One or more methods are disclosed for producing a pre-cooked and coated meat product that can be later heated in a dry-heat type oven appliance, resulting in a meat product with a coating that mimics an oil fried product. Pre-selected meat cuts can be marinated and coated, such as with a breading or batter. The crust of the coated product can be quick frozen, and subsequently cooked to brown and cook the coating and produce a desired color. The cooked and coated product can be vacuum sealed in cooking barrier film and sous vide cooked. The resulting product maintains the color and crispness of an oil fried product when it is later heated for eating, such as in an oven or air-fryer.

### CROSS-REFERENCE TO RELATED APPLICATIONS

This application claims priority to U.S. Provisional Application No. 63/488,811, entitled METHOD AND SYSTEM FOR PRE-PREPARED BREADED MEAT, filed on Mar. 7, 2023, of which is incorporated herein in its entirety by reference.

### BACKGROUND

Pre-packaged, pre-prepared food can be heated or finish cooked in a fraction of the time that it takes to fully prepare the same food, which makes it convenient and often economical. Some pre-prepared foods are breaded, battered, or otherwise coated, and can be finished for eating by cooking further or heating. However, often the finished coated product does not have the same texture, taste, mouthfeel, and other features of a freshly fried or similarly cooked product. Some end users, such as retail food establishments, cafeterias, and consumers utilize air fryers, ovens, or microwaves to heat pre-prepared food. These types of heating/cooking methods often produce in less than desired results, particularly for coated products.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems described herein are provided for producing a breaded, battered, or otherwise coated meat-food product as a pre-prepared, packaged item that can later be finished/prepared for eating by consumer or end user. Desired, pre-selected meat cuts can be marinated and coated, with the desired batter or breading. In some implementations, the coated product can be quick frozen to freeze the outer layer. The product can be cooked, such as par-fried, to cook the coating to a desired color and crispness. The cooked product is sous vide cooked in a vacuum sealed film. The resulting product maintains the color and crispness of an oil fried product when it is later heated for eating, such as in an oven.

In one implementation a method creating a pre-cooked, coated meat product can comprise marinating a pre-cut meat product, resulting in a marinated meat product. The marinated product can be coated with breading or batter. The coated product can be cooked to obtain a cooked and browned coating at a desired color. Further, the browned meat product can be vacuum sealed in a barrier cooking film. The packed product can additionally be sous vide cooked until the meat product is cooked to a pre-selected temperature for a pre-selected amount of time resulting in a cooked meat product.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is flow chart illustrating an exemplary implementation of a method of producing a breaded and pre-cooked product.

FIG. 2 is a component diagram illustrating one implementation of one portion of the method described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

In order to achieve desired and expected flavor, color, texture, etc., breaded and battered (e.g., coated) meat products are initially cooked to brown the coating. For example, the coated meat can be fried in oil, where oil frying of the coated meat produces a well-known and desired product (e.g., texture, flavor, color, mouthfeel, etc.), which is difficult to replicate using other methods, such as wet heat as produced by steam cookers. Typically, fried foods can produce a moist texture to the meat, while producing a crisp and tasty outer coating that is typically retained on the meat during the frying. Alternately, the coating of the coated meat product can be browned using conventional impingement ovens or air-fryer ovens.

In one aspect, end users may not have the resources or desire to oil fry the pre-prepared, coated meat product for final consumption. In some implementations, a method can be devised to create a pre-prepared (e.g., and pre-packaged), coated product that can be heated using a dry heat, such as an oven (e.g., conventional or air fryer) and produce a consumable product that mimics the desired characteristics of an oil fried product (e.g., comprising the preferred texture, flavor, color, mouthfeel, etc. of an oil-fried product). In some implementations, in this aspect, a meat product can be marinated and coated, such as with breading or batter. In these implementations, the marinated and coated product can be par-fried or air-fried to produce a desired coating color and crispness, without substantively cooking the meat itself. Further, the par-fired meat product can be packaged and subsequently sous vide cooked to produce a cooked and coated meat product (e.g., with a browned/cooked coating). The result is a pre-prepared, coated meat product that can be heated in a convention or air-fry oven to produce a consumable product with similar characteristics as those of an oil fried product.

The resulting product from this process provides a fully cooked product that is moist, with a crisp and tasty coating, from a pre-prepared and packed product that is later heated in an oven for consumption. Further, the resulting product can maintain a desired coating adherence to the meat that is typically not found in similar products. Current pre-preparing techniques avoid sous vide cooking because the combination of the protein from the meat and the coating have typically produced a soggy coating (e.g., not crisp), or a coating that does not properly adhere to the mat product, which is unsuitable for later heating in an oven. In these implementations, the innovative method uses a combination of marinating, par-frying, sous vide cooking, packaging, and freezing to produce a desirable, pre-cooked product that can be later heated for use as a consumer food product with a crisp, browned coating that adheres to the meat.

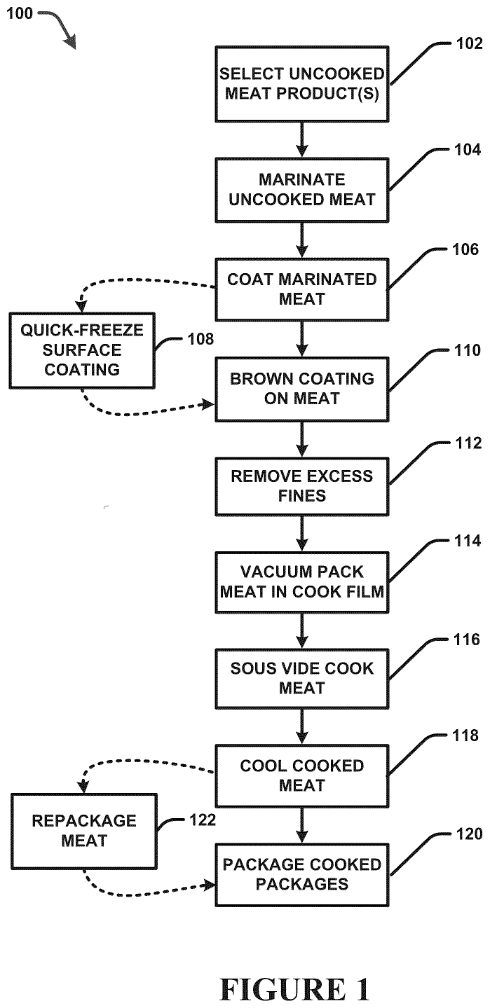

In one implementation, as illustrated in the flow diagram of FIG. 1, illustrating an example method of preparing pre-cooked, breaded meat products. At 102, in this exemplary method 100, uncooked and appropriately sized and shaped meat can be selected for processing. For example, chicken meat or other meats (e.g., such as chicken breast meat, or beef, pork, or other meats) can be sized and shaped to a desired end use (e.g., patties, tenders, nuggets, full breasts, etc.). At 104, the selected meat can be marinated. As one example, the meat can be vacuum tumbled with an approximately five to twenty-five percent (e.g., approximately fifteen percent) marinade, for fifteen to forty-five (e.g., approximately thirty) minutes, at zero to fifteen (e.g., approximately ten) revolutions per minute (RPM), and at a negative pressure of zero to thirty (e.g., approximately twenty) PSI or greater. However, any suitable marinating technique can be used for this process, selected for the desired outcome. As an example, the selected meat can be tumbled with the marinade at least until the surface is tacky and somewhat dry.

At 106, the marinated meat can be coated, such as battered or breaded. As an example, the marinated meat (e.g., chicken breast pieces) can be placed on a batter conveyor (e.g., a conveyor system with a coating applying section and a coating blow-off section) to generate a two to ten (e.g., six) percent target pickup of the coating (e.g., batter) on the product, to generate a desired batter coating on the product. As another example, the marinated meat can be placed on a conveyor system that drop applies a breading coating onto the marinated meat product, and has a smooth roller that results in a two to ten (e.g., six) percent target breading pick-up on the meat product, to generate a desired breading coating on the product.

It is anticipated that other known breading and battering (e.g., coating) techniques can be used to create the desired coated meat product, with varying amounts and types of coating. As one example, the coating on the meat product can produce or result in a desired adherence to the meat after cooking. In this example, this may be achieved by increasing the amount of protein in the batter or coating when compared with existing coating techniques. For example, an increase in protein can be achieved by adding or increasing the amount of egg product, dairy product (e.g., milk), soy product, and/or pea product (or similar protein) in the batter or coating. In this example, the control in the amount of protein in the coating can result in a control in the amount or type of adherence to the marinated product being coated.

At 108, in some implementations, a quick-freezing technique may be used to generate a crust freeze surface so that the meat product can be transferred to the next treatment while mitigating loss of the coating. As an example, Individual Quick Freezing (IQF) technology can be used, which typically utilizes a fluidized bed and cold air blowers to freeze smaller food products almost instantly. The quick-freezing process results in formation of small ice crystals, which do not damage cell integrity, and help retain the food product's original texture, color, moisture, and taste. It is anticipated that alternate quick-freezing technology can be used to create similar results, where the coating is retained on the product surface. In alternate implementations, the quick-freezing technique may not be applied to the coated meat product prior to the next processing step.

At 110, the coating on the coated (e.g., and quick-frozen) meat product can be browned to a desired consistency, such as to create a browned, crispy coating. For example, the coated product can be par fried to cook the coating, and control the color of the coating. As an example, the coated meat product can be par-fried in 360 to 425 (e.g., approximately 395) degrees Fahrenheit soy-bean and/or canola oils (e.g., and/or other food oils). The dwell time for the meat product can be adjusted to achieve the desired color of the coating; for example, a dwell time of thirty to seventy (e.g., approximately fifty) seconds may be used. It is anticipated that other frying techniques may be used to achieve similar results. For example, the coated meat product can be air-fried, or baked in a conventional-type oven to achieve the desired cooking or browning of the coating. In some implementations, the color may be adjusted to be slightly darker than a desired end user color, due to potential loss of the darker color during the later sous vide cooking process.

At 112, excess coating fines can be removed. That is, for example, the excess batter fines can be removed from edges or on top of par-fried meat products that may appear to be burnt (e.g., or darker than desired), otherwise loose, or undesirable (e.g., lumps, clots, under or over color, etc.). Any appropriate mechanical means can be used to remove the fines, such as using air jets, shaking, brushing, manual removal, etc. At 114, the par-fried meat product can be vacuum packed, such in an appropriate barrier cook film (e.g., appropriate for sous vide cooking), and in an arrangement and number appropriate for cooking and/or for end use. As an example, six pieces can be arranged in the package, with a three-quarter inch package depth.

At 116, the respective packages of meat product can be cooked using a sous vide cooking technique. Sous vide cooking typically uses heated fluid (e.g., water) that is maintained at a desired temperature throughout the cooking process, where the heated fluid is circulated around the packed food to help maintain a consistent contact temperature with the packaged food. As an example, liquid water or steam may be used as the heated fluid. In one example, one-hundred and thirty to one-hundred and sixty (e.g., approximately one-hundred and forty-five) degrees Fahrenheit steam can be applied to the respective package meat products for fifteen to forty-five (e.g., approximately thirty) minutes. This can be followed by one-hundred and thirty to one-hundred and sixty (e.g., approximately one-hundred and forty seven) degrees Fahrenheit temperature steam applied until the internal temperature of the meat product reaches one-hundred and thirty to one-hundred and sixty (e.g., approximately one-hundred and forty five) degrees Fahrenheit. This can be followed by application of one-hundred and thirty to one-hundred and sixty (e.g., approximately one-hundred and forty five) degrees Fahrenheit steam for forty to eighty (e.g., approximately sixty) minutes. As one example, a temperature probe can be placed in at least one of the meat products in the package, such as in one of the middle pieces, to detect the internal temperature of the meat product in the packaging during the sous vide process.

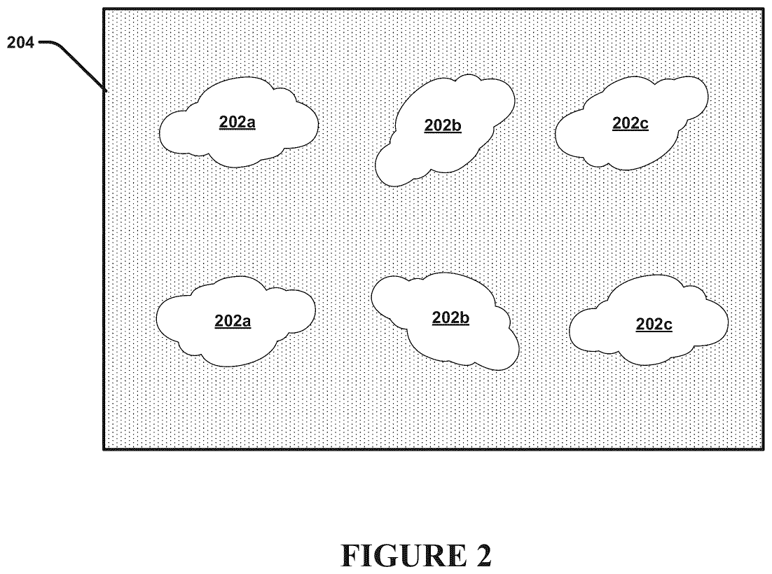

As an illustrative example, FIG. 2 illustrates one example of a set of packaged meat products. As illustrated, the meat products 202a, 202b, 202c can be arranged in a vacuum sealed barrier film package 204. Further, as illustrate, one or more temperature probes 206 can be inserted into one or more of the center pieces 202b to detect the temperature during the sous vide cooking. As an example, the temperature of the center pieces 202c may be appropriately representative of the respective meat pieces 202. In this way, for example, the cooking process can be appropriately controlled to obtain a desired cooking result, such as for hygiene (e.g., bacterial load or bacterial kill), texture, taste, etc.

Returning to FIG. 1, at 118, the cooked product can be cooled prior to packaging. As one example, under US FDA regulations, the temperature of a cooked product can be reduced from about one-hundred and twenty degrees Fahrenheit to about forty degrees Fahrenheit over a period of about five hours and thirty minutes. In one implementation, cooked product can be moved to an air-chill cooler, such as on racks or on a continuous conveyor, at least until a desired internal temperature of the cooked product is met.

At 120 of FIG. 1, the cooled, cooked product can be further packaged, such by placing a plurality of the individual cooked packages in a box for storage and or shipping. Further, in some implementations, the packaged products can be frozen for storage and/or shipping. As an example, the packaged products can be blast frozen (e.g., quick frozen) to quickly bring the temperature down to mitigate continued cooking and/or mitigate potential bacterial growth.

In some implementations, prior to packaging, at 122, the cooked product can be repackaged. For example, respective pieces of the cooked product can be removed from the packing in which it was sous vide cooked, and repackaged into a new bag, box, etc., which can be vacuum sealed or otherwise sealed in a desired number per package. In this implementation, once repackaged, the cooked products can be further packaged, as above.

Moreover, the word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter comprises been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure comprises been shown and described with respect to one or more implementations, equivalent alterations and modifications will occur to others skilled in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “comprises,” “having,” “comprises,” “with,” or variants thereof are used in either the detailed description or the claims, such terms are intended to be inclusive in a manner similar to the term “comprising.”

The implementations have been described here in. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A method for creating a pre-cooked, coated meat product, the method comprising:
marinating a pre-cut meat product, resulting in a marinated meat product;
coating the marinated meat product with breading or batter, resulting in a coated meat product;
cooking the coating of the coated meat product to obtain a browned coating to a predetermined color, resulting in a browned meat product;
vacuum sealing the browned meat product in a barrier cooking film; and
sous vide cooking the sealed, browned meat product until an internal of the meat product is cooked to a pre-selected temperature resulting in a cooked meat product.

2. The method of claim 1, further comprising quick freezing the coated meat product prior to cooking.

3. The method of claim 1, further comprising reducing the temperature of the cooked meat product from the pre-selected temperature to at least approximately forty degrees Fahrenheit in less than six hours.

4. The method of claim 1, further comprising removing coating fines from the browned meat product prior to vacuum sealing the browned meat product.

5. The method of claim 1, further comprising removing the cooked meat product from the barrier cooking film after sous vide cooking and repackaging the cooked meat product into packaging sent to a consumer.

6. The method of claim 1, further comprising quick freezing the cooked meat product.

7. The method of claim 1, the marinating comprising mixing the pre-cut meat product with five to twenty-five percent of marinade, for fifteen to forty-five minutes.

8. The method of claim 7, the marinating further comprising vacuum tumbling the pre-cut meat product with the marinade at zero to fifteen revolutions per minute (RPM), and at a negative pressure of zero to thirty PSI.

9. The method of claim 1, the coating comprising applying a batter to the marinated meat product to generate a two to ten percent target pickup of batter on the marinated meat product.

10. The method of claim 1, the coating comprising applying a breading to the marinated meat product to generate a two to ten percent target pickup of breading on the marinated meat product.

11. The method of claim 1, the cooking the coating comprising par-frying the coated meat product in 360 to 425 degree Fahrenheit oil.

12. The method of claim 11, the par-frying of the coated meat comprising par-frying with a dwell time of thirty to seventy seconds.

13. The method of claim 1, the sous vide cooking comprising applying a fluid heated to one-hundred and thirty to one-hundred and sixty degrees Fahrenheit to the sealed, browned meat product at least until an internal temperature of the sealed, browned meat product reaches one-hundred and thirty to one-hundred and sixty degrees Fahrenheit.

14. The method of claim 1, the sous vide cooking further comprising applying a fluid heated to one-hundred and thirty to one-hundred and sixty degrees Fahrenheit to the sealed, browned meat product for forty to eighty minutes after an internal temperature of the sealed, browned meat product reaches one-hundred and thirty to one-hundred and sixty degrees Fahrenheit.

15. A pre-cooked, meat product with a cooked, browned coating, which, when re-heated by a dry-heating method, results in a heated, cooked meat product with a browned and crispy coating that is adhered to the meat product, prepared by the following process:
marinating a pre-cut meat product, resulting in a marinated meat product, wherein the marinating comprises mixing the pre-cut meat product with five to twenty-five percent of marinade, for fifteen to forty-five minutes;
coating the marinated meat product with breading or batter, resulting in a coated meat product, wherein coating comprises applying a batter or breading to the marinated meat product to generate a two to ten percent target pickup of coating on the marinated meat product;
cooking the coating of the coated meat product to obtain a browned coating to a predetermined color, resulting in a browned meat product, wherein the cooking comprises par-frying;
vacuum sealing the browned meat product in a barrier cooking film; and
sous vide cooking the sealed, browned meat product until an interior of the meat product is cooked to a pre-selected temperature resulting in a cooked meat product, wherein the sous vide cooking comprises bringing an internal temperature of the sealed, browned meat product reaches one-hundred and thirty to one-hundred and sixty degrees Fahrenheit.

16. The product by process of claim 15, further comprising quick freezing the coated meat product prior to cooking.

17. The product by process of claim 15, further comprising reducing the temperature of the cooked meat product from the pre-selected temperature to at least approximately forty degrees Fahrenheit in less than six hours.

18. The product by process of claim 15, further comprising removing coating fines from the browned meat product prior to vacuum sealing the browned meat product.

19. The product by process of claim 15, further comprising quick freezing the cooked meat product.

20. A method for creating a pre-cooked, coated meat product, the method comprising:
marinating a pre-cut meat product, resulting in a marinated meat product;
coating the marinated meat product with breading or batter, resulting in a coated meat product;
quick freezing the coated meat product;
cooking the coating of the coated meat product to obtain a browned coating to a predetermined color, resulting in a browned meat product;
removing coating fines from the browned meat product;
vacuum sealing the browned meat product in a barrier cooking film;
sous vide cooking the sealed, browned meat product until an internal of the meat product is cooked to a pre-selected temperature resulting in a cooked meat product; and
reducing the temperature of the cooked meat product from the pre-selected temperature to at least approximately forty degrees Fahrenheit in less than six hours.
